(19) United States
(12) Patent Application Publication
(10) Pub. No.: US 2026/0243617 A1
(43) Pub. Date: Aug. 20, 2026

(54) TORQUE SENSOR MODULE

(71) Applicant: AL ROBOT CO., LTD., Gyeonggi-do (KR)

(72) Inventors: Daehee KANG, Incheon (KR); Joon Mo YANG, Incheon (KR)

(21) Appl. No.: 19/161,694

(22) PCT Filed: Jan. 15, 2024
(86) PCT No.: PCT/KR2024/000703

§ 371 Date: Sep. 2, 2025

(30) Foreign Application Priority Data
Mar. 2, 2023 (KR) 10-2023-0027956

(51) Int. Cl. G01L 3/10; G01L 5/00

(52) U.S. Cl. CPC G01L 3/108; G01L 5/0061

(57) ABSTRACT

The present invention relates to a torque sensor module, the torque sensor module of the present invention comprising: a body having, between a center hole thereof and the outer circumferential surface thereof, first sensitivity adjusting holes, strain measuring holes, second sensitivity adjusting holes, and stiffness adjusting holes repeatedly formed along the circumferential direction; and pairs of strain gauges attached to the respective both side wall surfaces of the respective strain measuring holes, wherein the centers of the first sensitivity adjusting holes, the second sensitivity adjusting holes, and the stiffness adjusting holes are disposed at the same first distance from the center of the body, the strain measuring holes are shaped into trapezoids of which the side closer to the center is longer than the side closer to the outer circumferential surface, and at least a partial area of the trapezoids may be arranged such that a circular arc at the first distance traverses same.

### TECHNICAL FIELD

The present invention relates to a torque sensor module, and more particularly, to a torque sensor module having a structure designed to improve sensitivity and rigidity compared to existing structures.

### BACKGROUND ART

In the case of industrial robots, a torque sensor mounted on a robot's wrist or the like is generally used to measure the force applied to a work object by a tool mounted on the robot arm. However, mounting a torque sensor on a robot's joint can complicate dynamic analysis and lead to accumulated errors, which is why this method is being researched more in the field of intelligent service robots than industrial robots.

When a robot arm or other part collides with an external object or person, it is impossible to detect collision, making it difficult to ensure safety through an active response. Since most intelligent robots currently in use must perform tasks in unknown and uncontrolled environments, they must operate with the safety of the robot and people as the top priority compared to industrial robots. For example, despite the effects of crosstalk such as bending force caused by people pushing or bumping into the robot arm, it is necessary to detect and precisely control the rotational force on the xy plane in the Cartesian coordinate system, i.e., the z-axis torque Tz.

A related prior document that may be referred to is Patent Application No. 10-2009-0115343 (26 Nov. 2009). However, existing torque sensor modules mounted on a robot arm or similar for detecting z-axis torque Tz have a trade-off between sensitivity and rigidity. Conventional torque sensor modules have the problem that optimizing rigidity and sensitivity is difficult due to the attachment of strain gauges to the spokes 300. The spokes are the parts that support rigidity, and limitations in performance exist.

### DETAILED DESCRIPTION OF THE INVENTION

### Technical Problem

Accordingly, the present invention has been devised to solve the aforementioned problems, and its purpose is to provide a torque sensor module that can be mounted on a robot arm for detecting z-axis torque Tz, which has a structure that can simultaneously improve sensitivity and rigidity.

### Means for Solving the Problem

First, to summarize the features of the present invention, a torque sensor module according to one aspect of the invention includes a body in which a first sensitivity adjustment hole, a strain measurement hole, a second sensitivity adjustment hole, and a rigidity adjustment hole are repeatedly formed along a circumferential direction between a central hole and an outer circumferential surface; and a pair of strain gauges, each attached to both side walls of the strain measurement hole, the centers of the first sensitivity adjustment hole, the second sensitivity adjustment hole, and the rigidity adjustment hole are arranged on the same first radial distance from the center of the body, and the strain measurement hole has a trapezoidal shape in which a central side is longer than an outer circumferential side, and an arc at the first radial distance intersects at least a portion of the inner area of the trapezoidal shape.

The first sensitivity adjustment hole and the second sensitivity adjustment hole may have the same shape.

Alternatively, a plurality of the rigidity adjustment holes may be formed, and the plurality of rigidity adjustment holes may have the same shape as the first sensitivity adjustment hole and the second sensitivity adjustment hole.

Alternatively, a plurality of the rigidity adjustment holes may be formed, and the plurality of rigidity adjustment holes may have a different shape from the first sensitivity adjustment hole and the second sensitivity adjustment hole.

A plurality of the rigidity adjustment holes may be formed, and the plurality of rigidity adjustment holes may be formed in two or more different shapes.

The size of the rigidity adjustment hole may be the same as the size of the first sensitivity adjustment hole and the second sensitivity adjustment hole.

Preferably, the size of the rigidity adjustment hole may be greater than the sizes of the first sensitivity adjustment hole and the second sensitivity adjustment hole.

The torque sensor module may further include a circuit board connected to signal lines from each strain gauge of the pairs of strain gauges attached to each of the plurality of strain measurement holes, the circuit board digitally processes strain detection signals from the signal lines to calculate a torque value for each strain measurement hole, and the torque value is used to calculate a torque value for a predetermined axis without being affected by crosstalk.

### Effect of the Invention

According to the torque sensor module of the present invention, it is possible to increase rigidity so that displacement due to external force (crosstalk) is minimal. This allows pure torque to be measured. It is also possible to increase sensitivity so that the precision and resolution of strain sensor operation can be improved. The existing torque sensor module had difficulty optimizing rigidity and sensitivity, and its performance was limited by the attachment of a strain gauge to the spoke part that supports rigidity.

By mounting the torque sensor module of the present invention, which has both sensitivity and rigidity as described above, on a robot arm, it is possible to precisely provide sensor information of the strain gauge, thereby enabling high performance, and, for example, even with the influence of crosstalk, such as a force (z-axis Bending Force) caused by a person pushing or bumping, it is possible to assist in the precise control of the rotational force on the xy-plane, that is, the z-axis torque Tz.

### BRIEF DESCRIPTION OF ACCOMPANYING DRAWINGS

The attached drawings, which are included as a part of the detailed description to help in understanding the present invention, will provide embodiments of the present invention and, together with the detailed description, explain the technical idea of the present invention.

FIG. 1 is a schematic perspective view of a torque sensor module according to one embodiment of the present invention;

FIG. 2 is a front view of the torque sensor module of FIG. 1;

FIG. 3 is a front view of a torque sensor module according to another embodiment of the present invention;

FIG. 4 is a front view of a torque sensor module according to still another embodiment of the present invention;

FIG. 5 is a front view of a torque sensor module according to still another embodiment of the present invention; and

FIG. 6 is an example of a torque calculation circuit using a strain gauge of the present invention.

### BEST MODE FOR CARRYING OUT THE INVENTION

The following describes the present invention in detail with reference to the accompanying drawings. In each drawing, the same components will be indicated by the same reference numerals. Detailed descriptions of functions and/or configurations already known will be omitted. The following description focuses on aspects necessary for understanding the operation of various embodiments, and omits descriptions of elements that may obscure the essence of the description. Furthermore, some components in the drawings may be exaggerated, omitted, or depicted schematically. The size of each component does not fully reflect the actual size, and therefore, the content described herein is not limited by the relative sizes or intervals of the components depicted in each drawing.

In describing the embodiments of the present invention, detailed descriptions of prior art related to the present invention are omitted when it is deemed that such descriptions would unnecessarily obscure the essence of the present invention. Furthermore, the terms used hereinafter are defined in consideration of the functions in the present invention, and may be changed according to the intention of a user, an operator, or a convention. Therefore, their definitions should be based on the content of the entire specification. The terms used in the detailed description are only for describing embodiments of the present invention, and should not be construed as limiting in any way. Unless otherwise explicitly stated, expressions in the singular form include the plural form. In this description, expressions such as “comprising” or “having” are intended to indicate certain features, numbers, steps, operations, elements, parts thereof, or combinations thereof, and should not be construed as excluding the existence or possibility of one or more other features, numbers, steps, operations, elements, parts thereof, or combinations thereof described.

In addition, terms such as first, second may be used to describe various components, but the components are not limited by the terms, and the terms are used only to distinguish one component from another.

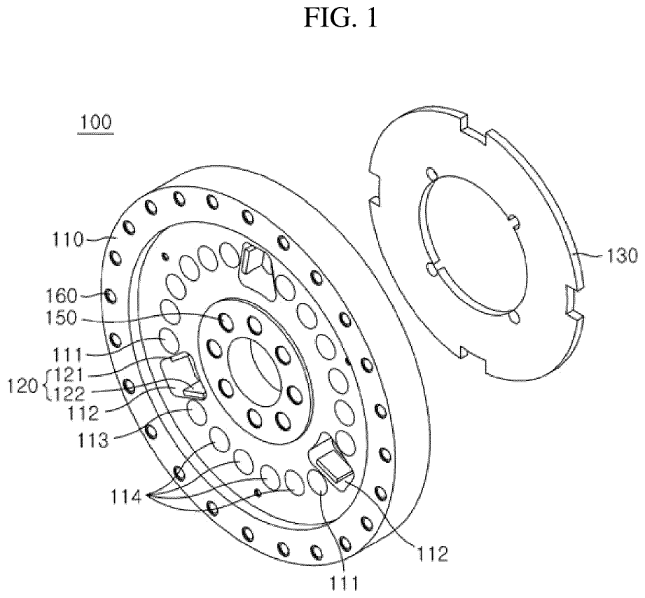

FIG. 1 is a schematic perspective view of a torque sensor module 100 according to one embodiment of the present invention.

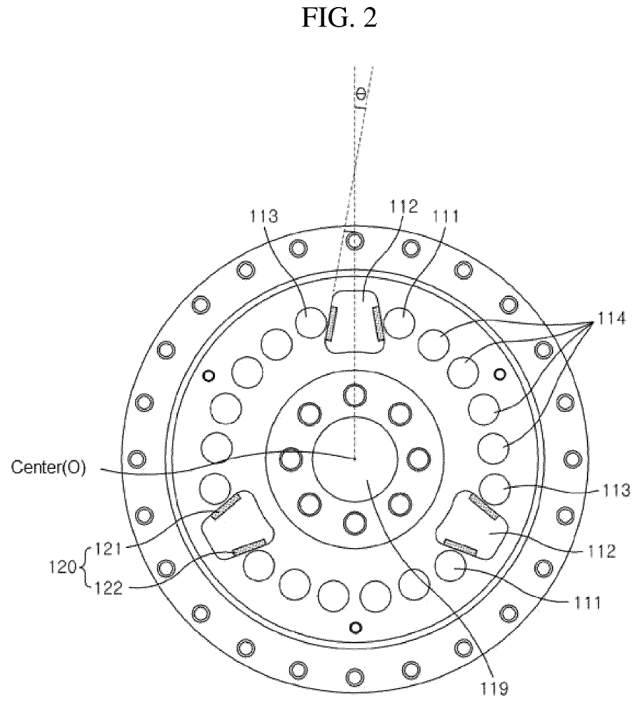

FIG. 2 is a front view of the torque sensor module 100 of FIG. 1.

Referring to FIGS. 1 and 2, a torque sensor module 100 according to one embodiment of the present invention may include a circular body 110 having a predetermined thickness, a pair of strain gauges 121, 122 attached to each of a plurality of strain measurement holes 112 of the body 110, and a circuit board 130 connected to signal lines from each of the strain gauges 121, 122 of the pairs of strain gauges 120 attached to each of the plurality of strain measurement holes 112.

The circuit board 130 may be manufactured in the form of a ring-type PCB (Printed Circuit Board) board as illustrated in FIG. 1, and may be mounted on one of both lateral surfaces of the body 110. The circuit board 130 is manufactured and mounted on the body 110 so that the part corresponding to the central hole 119 of the body 110 is open and no part of the circuit board 130 is caught. The circuit board 130 may be mounted on a predetermined axis provided on a robot arm or the like that intends to detect and control z-axis torque (Tz), which is one axis in a Cartesian coordinate system (e.g., xyz), through the central hole 119 of the body 110. The circuit board 130 may be equipped with circuit components such as an amplifier, an AD (Analog to Digital) converter, and an arithmetic unit for digitally processing detection signals from the signal lines of each strain gauges 121, 122 to calculate a torque value or the like.

The torque sensor module 100 of the present invention is designed so that the rigidity of the body 110 is increased so that the displacement due to external force (crosstalk) is reduced, thereby enabling the measurement of the pure torque to be measured, and so that the sensitivity is increased so that the precision and resolution of the strain sensor operation can be improved. Conventional torque sensor modules require strain gauges to be attached to the spokes that support this rigidity, making it difficult to optimize rigidity and sensitivity, and limiting performance.

By mounting the torque sensor module 100 of the present invention, which has both sensitivity and rigidity as described above, on a robot arm, it is possible to precisely provide sensor information of the strain gauges 121, 122, thereby enabling high performance, and, for example, even with the influence of crosstalk, such as a force (z-axis Bending Force) caused by a person pushing or bumping, it is possible to assist in the precise control of the rotational force on the xy-plane, that is, the z-axis torque Tz.

To this end, as shown in FIGS. 1 and 2, the body 110 includes a first sensitivity adjustment hole 111, the strain measurement hole 112, a second sensitivity adjustment hole 113, and a rigidity adjustment hole 114 disposed along the circumferential direction between the central hole 119 and the outer circumferential surface, and a hole array consisting of the first sensitivity adjustment hole 111, the strain measurement hole 112, the second sensitivity adjustment hole 113, and the rigidity adjustment hole 114 is formed by repeating the same sequence two or more times.

One or, preferably, a plurality of rigidity adjustment holes 114 are formed between the second sensitivity adjustment hole 113 and the first sensitivity adjustment hole 111, and may be formed in an appropriate number to appropriately reduce the overall weight while maintaining the rigidity of the sensor module 100.

The first sensitivity adjustment hole 111 and the second sensitivity adjustment hole 113 are each formed on both sides of the strain measurement hole 112 in the circumferential direction at a predetermined distance from the strain measurement hole 112, and the plurality of rigidity adjustment holes 114 may be formed at positions spaced apart by a predetermined pitch in the circumferential direction. Each hole located at both ends of the plurality of rigidity adjustment holes 114 can be formed to be spaced apart from the first sensitivity adjustment hole 111 or the second sensitivity adjustment hole 113 by a predetermined distance.

The strain measurement hole 112 is configured to attach the strain gauges 121, 122 for measuring the strain applied to the torque sensor module 100 at the position where it is mounted, and as shown in the drawings, the pair of strain gauges 120 are attached individually to opposite sides along the circumference of the strain measurement hole 112, such that they face each other.

The first sensitivity adjustment hole 111 and the second sensitivity adjustment hole 113, which are symmetrically positioned on each side of the strain measurement hole 112, are located at predetermined distances in the circumferential direction and are appropriately sized to enable the strain gauges 121, 122 to generate detection signals by measuring a suitable strain rate at the corresponding locations.

In addition, it is advantageous for strain rate measurement of the strain gauges 121, 122 by forming the strain measurement hole 112 in a trapezoidal shape in which the central side is longer than the outer circumferential side. Since the sensitivity of the strain gauges 121, 122 may vary depending on their placement, the distance from the first sensitivity adjustment hole 111 and the second sensitivity adjustment hole 113, the size of the holes, it is preferrable that the distance from the first sensitivity adjustment hole 111 and the second sensitivity adjustment hole 113 and the size of the holes must be formed at an appropriate distance and size according to the purpose, and the slopes of both side walls in the circumferential direction of the trapezoidal shape to which the strain gauges 121, 122 are attached also have an appropriate symmetrical slope. For example, it is preferable that the angle θ between the extension line of the line connecting the center of the trapezoidal shape and the center O of the torque sensor module 100 and the extension line of each of the both side walls of the trapezoidal shape is 50 degrees or less (θ is greater than 0).

Also, the first sensitivity adjustment hole 111, the second sensitivity adjustment hole 113, and the rigidity adjustment hole 114 are illustrated as being circular, but are not limited thereto, and may be formed in various shapes such as circles, ellipses, or polygons such as trapezoids, triangles, squares, and pentagons.

The plurality of rigidity adjustment holes 114 may be formed at positions spaced apart by a predetermined pitch in the circumferential direction. A suitable number of rigidity adjustment holes 114 may be formed between the second sensitivity adjustment hole 113 and the first sensitivity adjustment hole 111, with appropriate size and spacing, so as to maintain a predetermined level of rigidity. In a conventional related prior document, Patent Application No. 10-2009-0115343 (2009Nov. 26.), a structure in which a gauge is attached to a spoke 300 could not guarantee rigidity and sensitivity. In contrast, the rigidity adjustment hole 114 of the present invention is not formed in a spoke-type structure, but rather in a surface of the body 110 that extends to its outer circumferential area, so it is possible to enhance rigidity and allows the torque sensor module 100 to better maintain its structural integrity compared to the spoke-type structure.

Furthermore, as in FIGS. 1 and 2, it is preferable that the centers of the first sensitivity adjustment hole 111, the second sensitivity adjustment hole 113, and the rigidity adjustment holes 114 are arranged on the same first radial distance r1 from the center O of the body 110. Accordingly, it is possible to provide strain sensor information for deformation in any direction in a balanced manner.

The trapezoidal strain measurement hole 112 may be formed such that its center is located at the same first radial distance r1 from the center O, that is, along the same arc centered on O, as the first sensitivity adjustment hole 111, the second sensitivity adjustment hole 113, and the rigidity adjustment hole 114. However, this configuration is not limited thereto, and the strain measurement hole 112 may alternatively be arranged such that an arc at the same distance r1 from the center O intersects at least a portion of the inner area of the trapezoidal shape, excluding its four edges.

In addition, the sensitivity of the strain gauges 121, 122 may vary depending on their placement on both side walls of the strain measurement hole 112. For example, when the trapezoidal strain measurement hole 112 is formed so that its center is located on the same first radial distance r1 from the center O, that is, on the same arc centered on O, as the first sensitivity adjustment hole 111, the second sensitivity adjustment hole 113, and the rigidity adjustment hole 114, the center of the bottom surface of the strain gauges 121, 122 may be arranged on the same first radial distance r1. However, it is preferable that the center of the bottom surface of the strain gauges 121, 122 be located within the trapezoidal hole at a distance less than r1 from the center O.

In FIGS. 1 and 2, the rigidity adjustment holes 114 may be formed in an appropriate number to reduce the overall weight while maintaining the rigidity of the torque sensor module 100. Additionally, to further reduce weight, a suitable number of holes 150 may be formed on the extra surface of the body 110 located at a second radial distance r2 from the center O, and additional holes 160 may be formed on another extra surface located at a third radial distance r3 from the center O. These holes 111, 112, 113, 114, 150, 160 may also be used for installing cables or components for connection to the circuit board 130, or for coupling with other parts that constitute the robot.

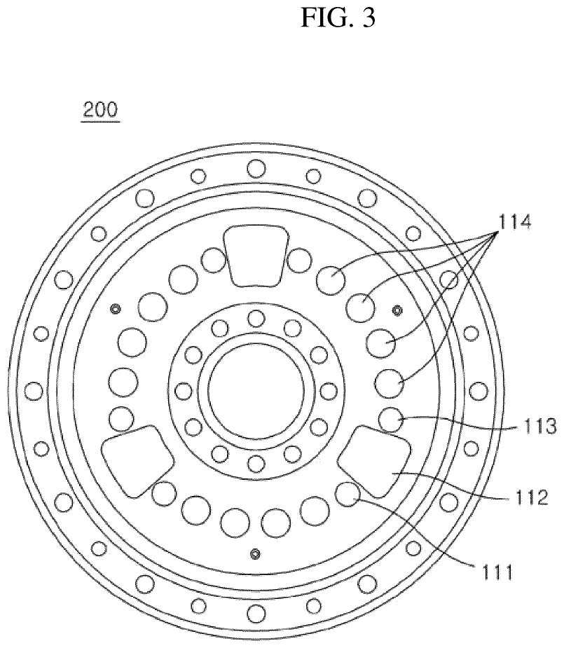

FIG. 3 is a front view of a torque sensor module 200 according to another embodiment of the present invention.

Referring to FIG. 3, a torque sensor module 200 according to another embodiment of the present invention may be formed so that the first sensitivity adjustment hole 111 and the second sensitivity adjustment hole 113 have the same shape (e.g., circular) as in FIGS. 1 and 2, and the plurality of rigidity adjustment holes 114 may also be formed in the same shape (e.g., circular) as the first sensitivity adjustment hole 111 and the second sensitivity adjustment hole 113.

However, in FIGS. 1 and 2, the size (i.e., diameter) of the rigidity adjustment hole 114 is illustrated as being equal to that of the first sensitivity adjustment hole 111 and the second sensitivity adjustment hole 113, but this configuration is not limited thereto, and as shown in FIG. 3, the size of the rigidity adjustment hole 114 may be smaller than that of the first sensitivity adjustment hole 111 and the second sensitivity adjustment hole 113, although preferably, it is advantageous for weight reduction of the sensor module to form the rigidity adjustment hole with a larger size.

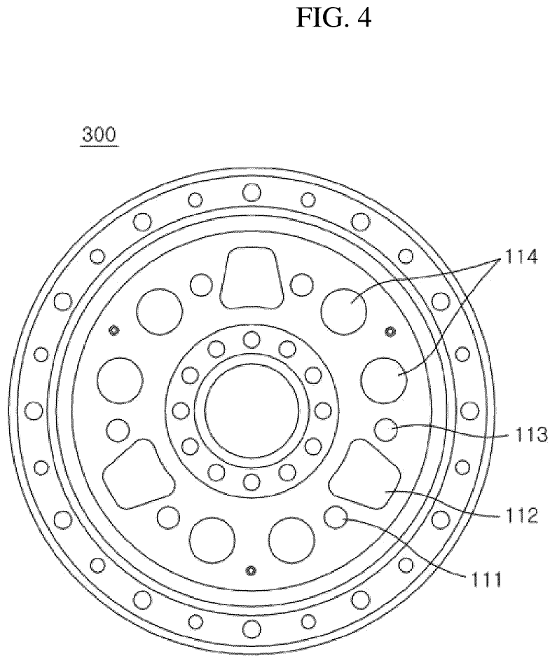

FIG. 4 is a front view of a torque sensor module 300 according to still another embodiment of the present invention.

Referring to FIG. 4, a torque sensor module 300 according to still another embodiment of the present invention may be formed so that the first sensitivity adjustment hole 111 and the second sensitivity adjustment hole 113 have the same shape (e.g., circular) as in FIGS. 1 and 2, and the plurality of rigidity adjustment holes 114 may also be formed in the same shape (e.g., circular) as the first sensitivity adjustment hole 111 and the second sensitivity adjustment hole 113.

However, in this embodiment, the size (i.e., diameter) of the first sensitivity adjustment hole 111 and the second sensitivity adjustment hole 113 is the same as in FIG. 3, but the size of the rigidity adjustment hole 114 is larger than in FIG. 3. Accordingly, the number of rigidity adjustment holes 114 is reduced, but it may be advantageous in reducing the total weight of the sensor module depending on the purpose.

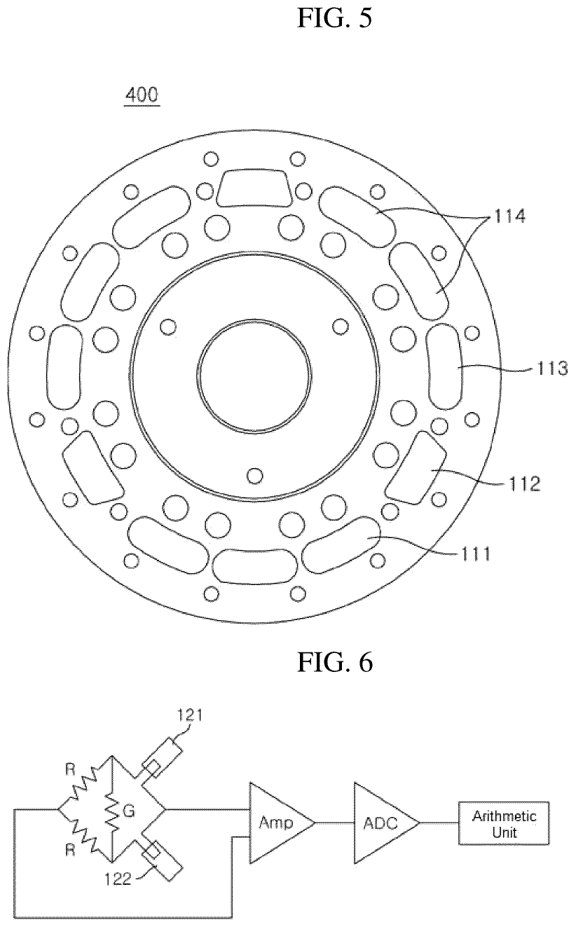

FIG. 5 is a front view of a torque sensor module 400 according to still another embodiment of the present invention.

Referring to FIG. 5, a torque sensor module 400 according to still another embodiment of the present invention may be formed so that the first sensitivity adjustment hole 111 and the second sensitivity adjustment hole 113 have the same shape (e.g., circular), and the plurality of rigidity adjustment holes 114 may be formed in a different shape (e.g., elliptical) from the first sensitivity adjustment hole 111 and the second sensitivity adjustment hole 113.

In this embodiment as well, it is preferable that the size (i.e., diameter) of the first sensitivity adjustment hole 111 and the second sensitivity adjustment hole 113 is the same, and although the size of the rigidity adjustment hole 114 is larger than the size of the first sensitivity adjustment hole 111 and the second sensitivity adjustment hole 113, depending on the case, the rigidity adjustment hole (114) may have the same or smaller passing area compared to the first sensitivity adjustment hole 111 and the second sensitivity adjustment hole 113.

In addition to these embodiments, the plurality of rigidity adjustment holes 114 may be formed to include two or more different shapes (a combination of circles, ellipses, or polygons such as trapezoids, triangles, squares, or pentagons is possible), and in this case, the first sensitivity adjustment hole 111 and the second sensitivity adjustment hole 113 may also be implemented in various forms such as ellipses or polygons such as trapezoids, triangles, squares, or pentagons in addition to circles.

FIG. 6 is an example of a torque calculation circuit using a strain gauge of the present invention.

Referring to FIG. 6, the circuit board 130 may include a torque calculation circuit including an amplifier (Amp), an AD (Analog to Digital) converter (ADC), and an arithmetic unit for calculating a torque value or the like, connected to the signal lines of each strain gauges 121, 122.

The amplifier (Amp) amplifies the output signal of the Wheatstone bridge, which serves as the detection signal generated by the strain gauges 121, 122 included in the Wheatstone bridge circuit. The AD converter (ADC) then converts the amplified signal into a digital value, and the arithmetic unit may calculate the torque value at the attachment position of the strain gauges 121, 122 based on the digital value.

As such, the circuit board 130 may digitally process the strain detection signals from the signal lines of each strain gauges 121, 122 to calculate a torque value for each strain measurement hole 112, and furthermore, may use the torque value to calculate the torque value Tz for a predetermined single axis without the influence of crosstalk and use it for the control of a robot or the like. In the torque sensor module, when measuring the torque component required for control, the force or torque component of other axes affects the torque value output of the torque sensor module. This phenomenon in which an undesired force or torque component affects the torque value output of the torque sensor module is called crosstalk (cross-interference or external force).

As shown in FIG. 6, the method of calculating a torque value from detection signals corresponding to the strain of strain gauges 121, 122, by configuring a Wheatstone bridge circuit that includes the elements of the strain gauges and appropriately selected resistors R, R, G is well known. Therefore, a detailed description is omitted here. For torque calculation methods, reference may be made to related prior documents such as Patent Application No. 10-2009-0115343 (filed on Nov. 26, 2009).

As described above, according to the torque sensor module 100, 200, 300, 400 according to the present invention, the rigidity is increased so that displacement in response to external force (crosstalk) is small, allowing the pure torque to be measured, and the sensitivity is increased so that the precision and resolution of the strain sensor operation can be improved. The existing torque sensor module had difficulty optimizing rigidity and sensitivity, and its performance was limited by the attachment of a strain gauge to the spoke part that supports rigidity. By mounting the torque sensor module of the present invention, which has both sensitivity and rigidity as described above, on a robot arm, it is possible to precisely provide sensor information of the strain gauge, thereby enabling high performance, and, for example, even with the influence of crosstalk, such as a force (z-axis Bending Force) caused by a person pushing or bumping, it is possible to assist in the precise control of the rotational force on the xy-plane, that is, the z-axis torque Tz.

As described above, the present invention has been explained with reference to specific components, limited embodiments, and drawings, which are provided solely to aid in a comprehensive understanding of the invention. However, the invention is not limited to these embodiments. Various modifications and alterations may be made by those skilled in the art without departing from the essential characteristics of the invention. Accordingly, the scope of the invention should not be construed as being limited to the disclosed embodiments, and all technical ideas that are equivalent or substantially similar to the claims set forth below should be interpreted as falling within the scope of the invention.

What is claimed is:

1. A torque sensor module, comprising:
a body in which a first sensitivity adjustment hole, a strain measurement hole, a second sensitivity adjustment hole, and a rigidity adjustment hole are repeatedly formed along a circumferential direction between a central hole and an outer circumferential surface; and
a pair of strain gauges, each attached to both side walls of the strain measurement hole,
wherein the centers of the first sensitivity adjustment hole, the second sensitivity adjustment hole, and the rigidity adjustment hole are arranged on the same first radial distance from the center of the body,
wherein the strain measurement hole has a trapezoidal shape in which a central side is longer than an outer circumferential side, and an arc at the first radial distance intersects at least a portion of the inner area of the trapezoidal shape.

2. The torque sensor module of claim 1, wherein the first sensitivity adjustment hole and the second sensitivity adjustment hole have the same shape.

3. The torque sensor module of claim 1, wherein a plurality of the rigidity adjustment holes are formed, and the plurality of rigidity adjustment holes have the same shape as the first sensitivity adjustment hole and the second sensitivity adjustment hole.

4. The torque sensor module of claim 1, wherein a plurality of the rigidity adjustment holes are formed, and the plurality of rigidity adjustment holes have a different shape from the first sensitivity adjustment hole and the second sensitivity adjustment hole.

5. The torque sensor module of claim 1, wherein a plurality of the rigidity adjustment holes are formed, and the plurality of rigidity adjustment holes are formed in two or more different shapes.

6. The torque sensor module of claim 1, wherein the size of the rigidity adjustment hole is the same as the size of the first sensitivity adjustment hole and the second sensitivity adjustment hole.

7. The torque sensor module of claim 1, wherein the size of the rigidity adjustment hole is greater than the sizes of the first sensitivity adjustment hole and the second sensitivity adjustment hole.

8. The torque sensor module of claim 1, further comprising a circuit board connected to signal lines from each strain gauge of the pairs of strain gauges attached to each of the plurality of strain measurement holes,
wherein the circuit board digitally processes strain detection signals from the signal lines to calculate a torque value for each strain measurement hole.

9. The torque sensor module of claim 8, wherein the torque value is used to calculate a torque value for a predetermined axis without being affected by crosstalk.
